(19) United States
(12) Patent Application Publication
(10) Pub. No.: US 2012/0131532 A1
(43) Pub. Date: May 24, 2012

(54) Substrate Noise Assessment Flow In Mixed-Signal And SOC Designs

(76) Inventor: Hazem Hegazy, Cairo (EG)

(21) Appl. No.: 13/163,665

(22) Filed: Jun. 17, 2011

Related U.S. Application Data
(60) Provisional application No. 61/355,695, filed on Jun. 17, 2010.

(51) Int. Cl. G06F 17/50

(52) U.S. Cl. 716/115

(57) ABSTRACT

A substrate noise checking methodology is disclosed. A tool is provided that aggregates the noise effect of one or more of digital noise injectors on one or more receptors. The tool also provides a propagation macro-model for the noise from the digital noise injectors. With both models combined, full chip substrate noise assessment flow can be achieved.

### RELATED APPLICATIONS

This application claims priority to U.S. Provisional Patent Application No. 61/355,695, entitled “Noise Assessment Flow In Mixed-Signal And SOC Designs,” filed on Jun. 17, 2010, and naming Hazem Hegazy as inventor, which application is incorporated entirely herein by reference.

### FIELD OF THE INVENTION

The present invention is directed to the determination of substrate noise for electronic design automation. Various implementations of the invention may be particularly suitable for modeling substrate noise in mixed-signal and system-in-chip (SOC) designs, so that excessive noise can be reduce or otherwise addressed.

### BACKGROUND OF THE INVENTION

The shrinkage of MOS transistor sizes and the rather dramatic increase of system-on-chip (SOC) solutions available today mandated the integration of millions of digital gates along with high performance analog transistors on the same die. This unprecedented level of integration requires the coexistence of sensitive analog transistors, known for their little noise margins, with digital gates that switch rail-to-rail. The performance of analog transistors can be severely impacted by transient noise coupling from digital aggressors over the supply lines, package leads, and the common substrate. All three integration artifacts lead to the modulation of analog transistor performance parameters by the switching transients of digital gates.

Designers are starting to realize how serious the substrate noise problem is. Previous attempts to minimize substrate noise were largely ad-hoc. A particular guard ring geometry that worked in one design would be used repeatedly even though the substrate noise requirements probably differed. Such ad-hoc techniques are no longer able to solve the substrate noise problem in large designs. In fact, for current and future designs, substrate noise is considered to be a major “showstopper” to large levels of integration.

Designing for substrate noise remains somewhat an “art” or even “black magic”. Tricks are employed without an understanding for why they work, or how they can be optimized. Analog designers typically design the system assuming a specific substrate noise value that is a result of intuition or previous experience rather than quantified simulation results. The accuracy of such estimates is typically not verified. As a result, systems may be severely over-designed or, even worse, under-designed for substrate noise robustness.

Historically, there are quite a few electronic design automation (EDA) tools that tackled the complex problem of substrate noise coupling. They typically have made a trade-off between accuracy and speed. In the last two decades, designers preferred accuracy over speed. With the growing design size and complexity, however, substrate noise problem is becoming substantially larger. Accuracy is achievable yet, no longer feasible. The size of an extracted 3D resistive network for a substrate tends to be prohibitively large, given the limited capacity of SPICE simulators. Even with model-order-reduction (MOR), the size of the extracted network is far from being manageable by current circuit simulators.

It should be noted that substrate network extraction is unavailing without interconnect resistance extraction of supply and ground rails. Without these resistors, transistors bulk nodes are connected to perfect ground and power rails. Thus, substrate currents pass through the least resistive path which is through the perfect supply rails. In reality, this is not the case. Power and ground resistive network is the main cause of rail bounce which enables most of injected digital substrate noise to impact analog transistors. In short, full chip, interconnect and substrate extraction should be performed in order to analyze the substrate noise impact on design's performance. Therefore, the capability of conventional electrical simulators to perform these tasks is becoming doubtful.

Most of researchers tend to build solutions for substrate coupling are following bottom-up approach. The result is usually a representation of substrate bulk in a 3D resistive matrix form. A tweaked version of that form could use macro-models to represent the 3D resistive matrix yet in a compact form. Obviously, the former is accurate but no longer affordable by conventional simulators. The latter is useful only on small scale designs. The bigger the system is, the larger the number of injectors that exist. Such large numbers overwhelm the simulation as an affordable means of assessment. Capturing noise propagation is still easier than capturing noise generation from all these millions of gates. Relying on analog simulation to calculate the substrate current injected from digital gates, now treated as “circuits,” is not economical.

### BRIEF SUMMARY OF THE INVENTION

Aspects of the invention relate to a top-down approach to determine substrate noise for mixed-signal and system-on-chip circuit designs. Various implementations of the invention employ models that exploit the high level abstraction of the relation between noise injectors and receptors followed by circuit formation of noise “effect” rather than its physical representation.

### BRIEF DESCRIPTION OF THE DRAWINGS

FIGS. 1 and 2 illustrate a computer network having a host or master computer and one or more remote or servant computers that may be used to implement various embodiments of the invention.

FIG. 3 shows a physical representation of the substrate noise problem.

FIG. 4 illustrates how an effective noise source can represent the digital injector and account for attenuation through substrate.

FIG. 5 illustrates how injected current into the substrate is transformed into noise voltage, according to Ohm's law.

FIG. 6 illustrates how noise injection is independent of noise reception and depends only on the current injected and the geometrical/physical parameters of substrate bulk.

FIG. 7 illustrates a schematic description of the electrical noise system for a substrate as seen from the perspective of an analog receptor.

FIG. 8 illustrates the currents that are the main source of noise from the digital domain for analog receptors.

FIG. 9 illustrates an inverter's output transition against input stimulus.

FIG. 10 illustrates how a simulation netlist can be prepared for post-layout simulation by adding stimulus on the input side and then varying the load capacitance on the output side.

FIG. 11 illustrates a graph comparing values of Iₘₐₓ that have been modeled according to various embodiments of the invention against prospective values from a “golden reference” simulated netlist.

FIGS. 12A and 12B illustrate error distribution versus field solver data according to various embodiments of the invention.

### DETAILED DESCRIPTION OF THE INVENTION

### Exemplary Operating Environment

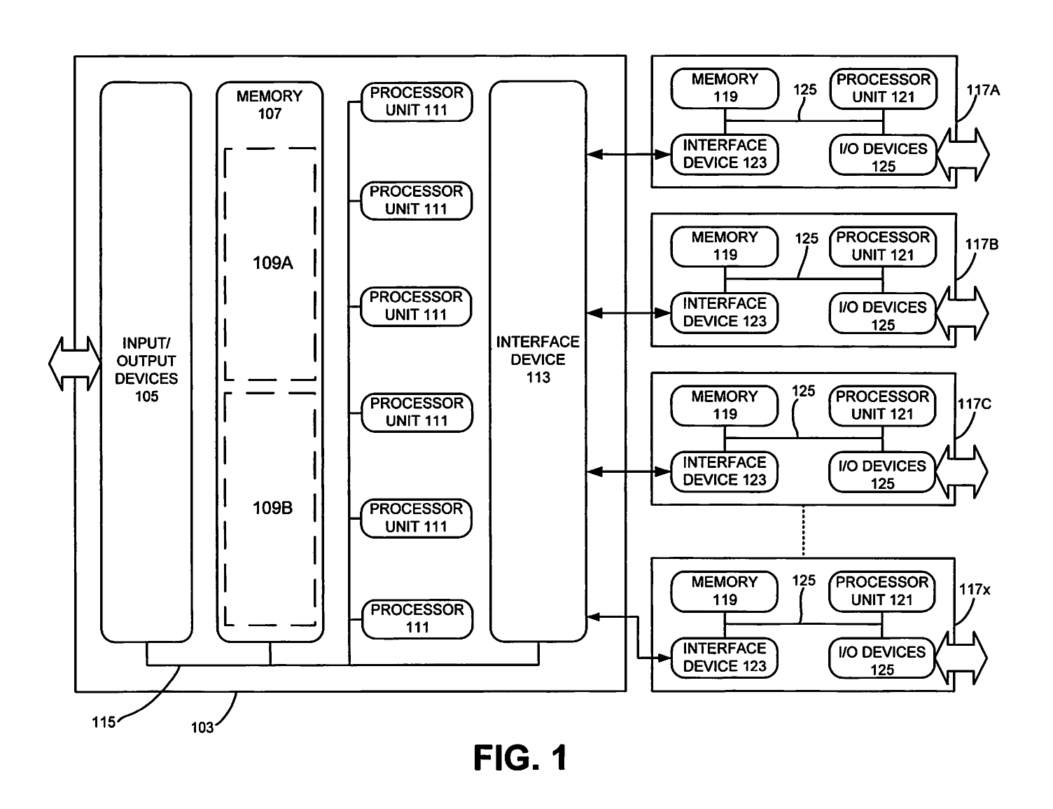

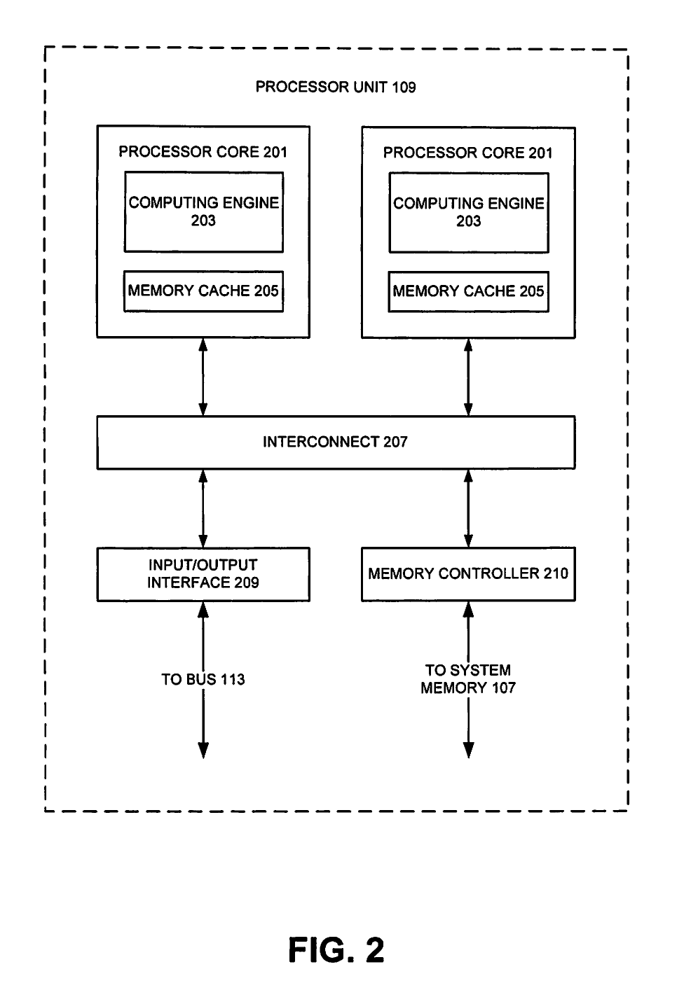

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIGS. 1 and 2. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### To-Bottom Approach for Substrate Noise Assessment

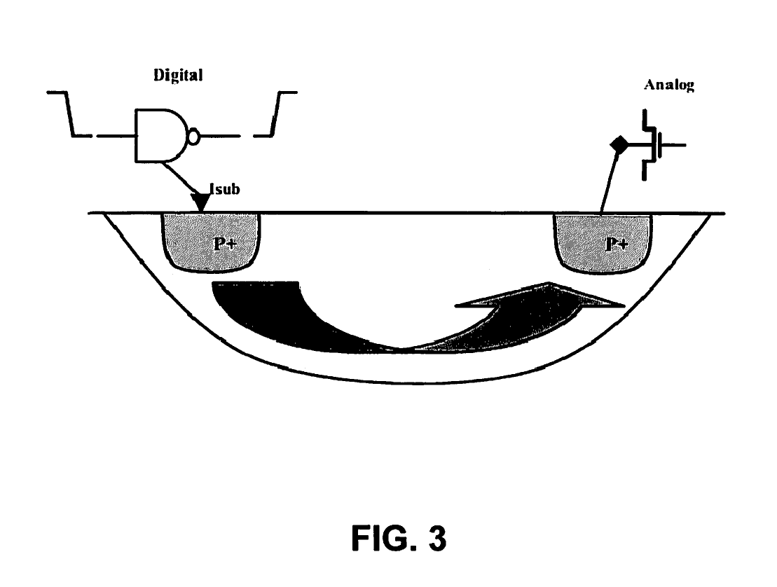

FIG. 3 shows a physical representation of the substrate noise problem under study. A digital injector and analog receptor with the substrate bulk working as channel/medium in between. Only one injector and one receptor are shown for simplification. As will be appreciated by those of ordinary skill in the art, however, the same concept scales to consider several injectors and receptors.

FIG. 3 illustrates the detachment of noise generation from the noise reception mechanism. Such separation enables two things. First, it enables digital noise injection macro-modeling based on digital libraries definition without digital simulation. Second, it enables the transformation of injected noise “effect” into an attenuated noise on the analog victim side. No substrate network is to be streamed out to simulators, just noise impact. Moreover, analog receptor catches noise from only one pin; the bulk pin. To be veracious, source and drain pins are also susceptible to noise. However, pn-junction capacitance formed by source/drain-bulk region represents a blockage to most of these noises. Accordingly, the bulk pin is the most sensitive pin to the pickup of noisy substrate voltage.

Analog receptors do not recognize which digital gate is injecting and which is not. They only sense their effect which might vary due to geometrical proximity. With this in mind, transferring the “effect” of injected noise to analog bulk pin interprets what is happening on the physical level, i.e., on real silicon.

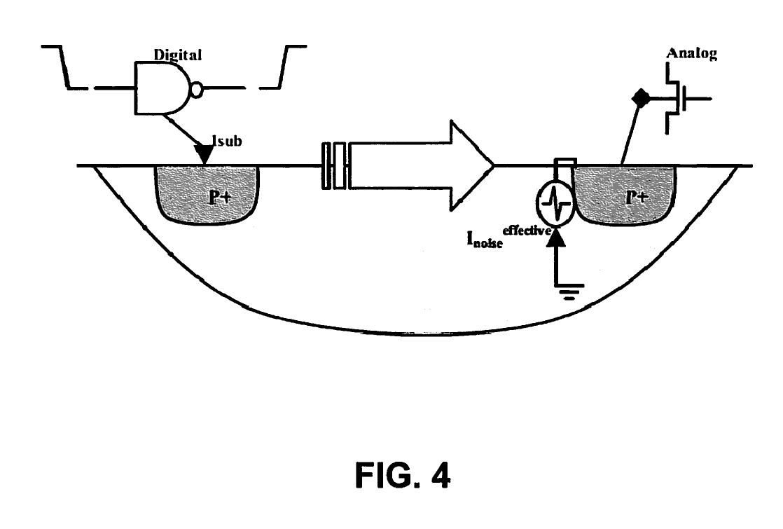

FIG. 4 illustrates how an effective noise source can represent the digital injector and account for attenuation through substrate. This approach eliminates the need of a 3D resistive network to link injectors to receptors. Thus, a compact analog-only netlist, with noise effect added as noise voltages captures the physical picture while being considerate to SPICE simulators' capabilities.

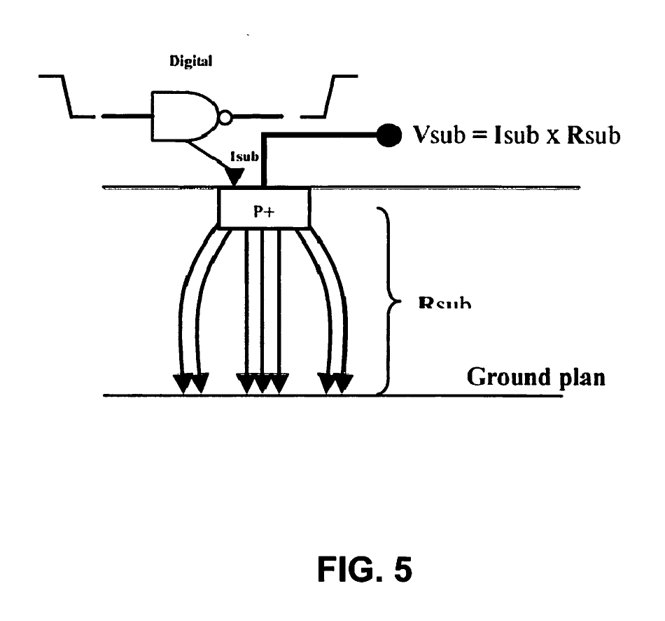

The view illustrated in FIG. 4 is merely an interpretation of the physical view to interface the physical model to SPICE. As previously mentioned, injectors produce noise regardless of the receptor's presence. Digital gates pass source/drain currents while toggling from high to low and vice versa. The current depends on load capacitance value and rise/fall time of gate toggling stimuli. Accordingly, the form of noise it produces is a current pulse that is transduced to a voltage pulse by the input resistance of the substrate at a particular injection point. FIG. 5 then illustrates how injected current into the substrate is transformed into noise voltage, according to Ohm's law.

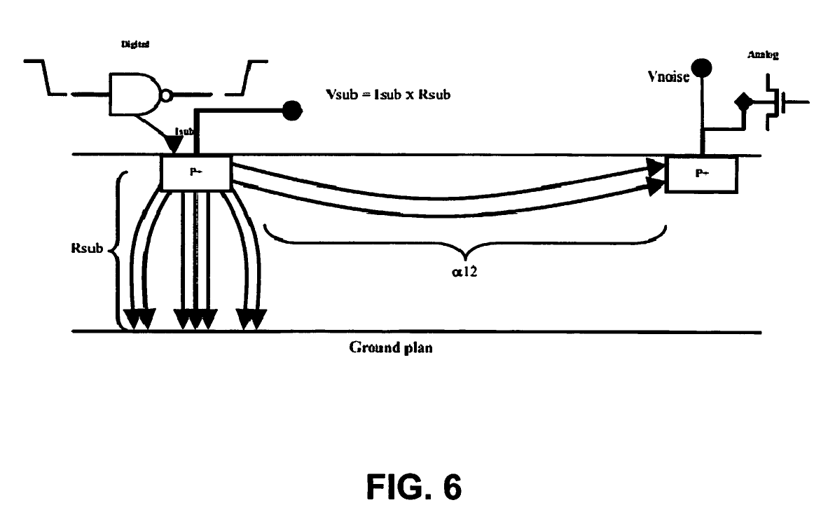

The substrate resistance from a substrate contact to ground plan is a function of contact geometry and substrate thickness/resistivity. Thus, noise injection is independent of noise reception and depends only on the current injected and the geometrical/physical parameters of substrate bulk. As also see from the figures, a substrate voltage is now produced by digital gates which causes general bulk voltage rising. Sensitive analog block picks it up through transistors' bulk contacts. During the process V_{sub} is reduced to Vₙₒᵢₛₑ at analog side. Then, it is being attenuated through propagation in resistive substrate. FIG. 6 demonstrates this relationship in detail.

As seen in this figure, α₁₂ is an attenuation factor that depends on both geometry of injector/receptor and separation between them. Equations (2) through (4) capture the relation between injected substrate noise current from digital gate and “sensed” noise voltage at analog side.

$$\begin{matrix}{I}_{sub} = {I}_{sw} \times ( {( \frac{{Z}_{ip}}{{R}_{sub}} )}_{digital} + 1 ) & ( 1 ) \\ {V}_{sub} = {I}_{sub} \times {R}_{sub} & ( 2 ) \\ {V}_{noise} = {α}_{12} \times {V}_{sub} & ( 3 ) \\ {V}_{noise} = {α}_{12} \times {R}_{sub} \times {I}_{sub} & ( 4 )\end{matrix}$$

where I_{sub} is the portion of supply switching current, I_{sw}, that goes to the substrate. The other portion of this current goes to the external supply through interconnects and package impedance, Zᵢₚ, to the outside of the chip. Package impedance is typically a known value or selectable by a designer.

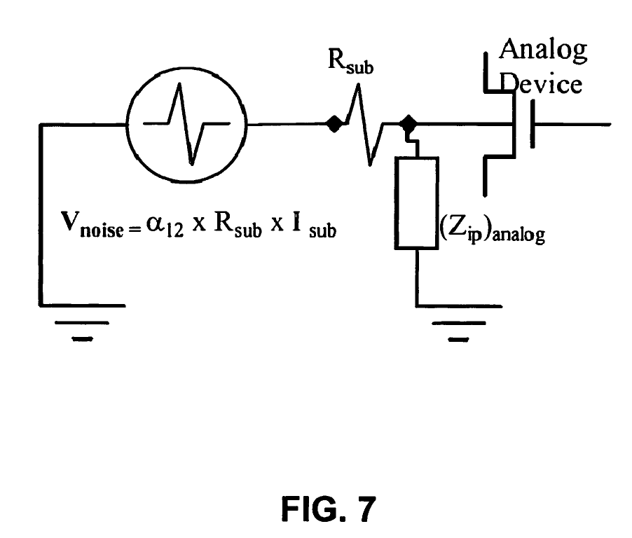

The entire electrical view of the system is captured by equation (4). It is a simple relation that relates injected noise current to the sensed noise voltage at the analog device bulk pin. In other words, if R_{sub} and α₁₂ are defined for all digital gates, then the substrate 3D network representation is no longer needed. FIG. 7 then illustrates a schematic description as seen from the perspective of an analog receptor, and SPICE representation.

### Supply Rails Switching Current

During transition to a high state, digital gates are charging load capacitances connected to their output nodes. Discharging current happens when a digital gate goes from high to low state. In the latter case, all the charge accumulated on load capacitances during charging process is discharged to ground and a low state at gate's output node occurs. During rising output, almost null current passes through ground node. All the activity is occurring only on power supply node (vice versa in case of falling output). This observation divides the problem into two components, gate rising condition where almost no current passes through ground node and gate falling condition where almost all the current is passing through ground node (null on supply node).

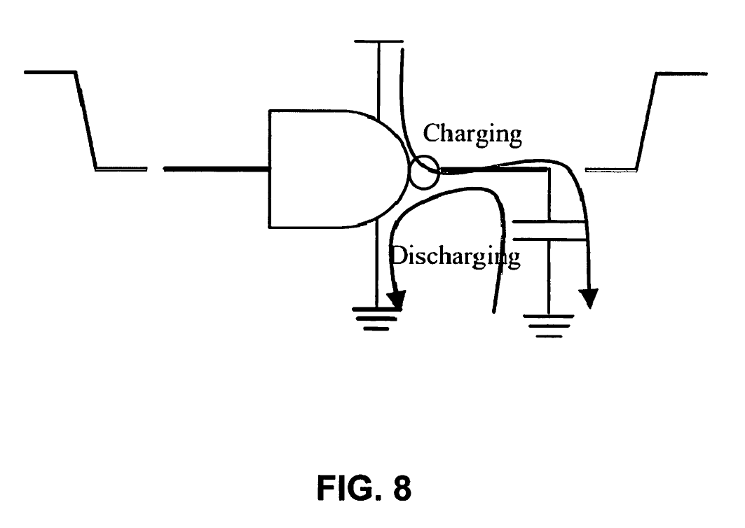

At gate level, only current/charge is being exchanged during gate output's transition. These currents are the main source of noise from the digital domain, as shown in FIG. 8. Leakage/off currents in off/idle state are another source of noise that doesn't depend on gates' activity. In general, it is of much lower magnitude and frequency components compared to main switching currents.

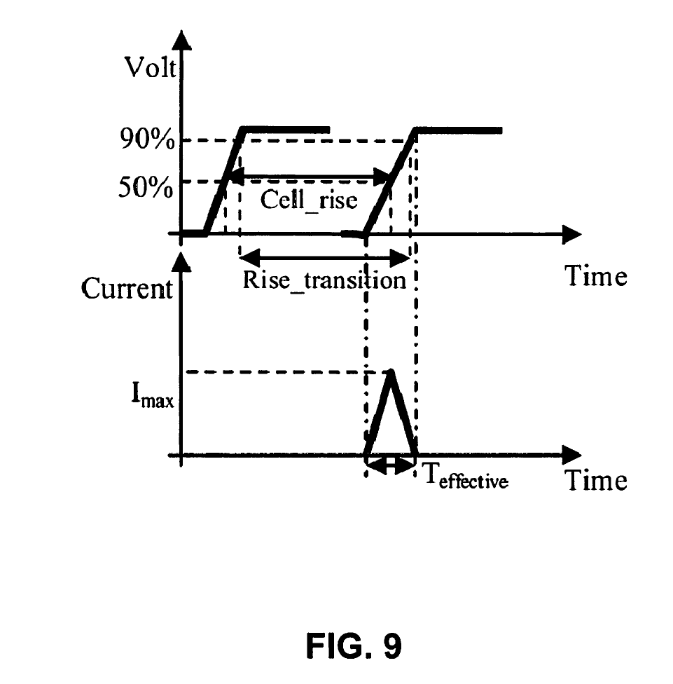

Various implementations of the invention allow a designer to reuse pre-characterized digital library data to model switching currents in supply rails. FIG. 9 illustrates an inverter's output transition against input stimulus. The corresponding supply current is represented in lower section. The shape of the current waveform can be approximated to a triangle as first order model, as seen in this figure.

Accordingly, two parameters can be identified: Iₘₐₓ and T_{effective}. The parameters can be derived according to various embodiments of the invention as follows:

$$\begin{matrix}{T}_{eff} = 2 \times ( rise\_transition - cell\_rise + 0.4 \times risetime ) & ( 5 ) \\ {I}_{max} = ( Total\_gate \_switching \_energy ) \times ( {V}_{dd} \times {T}_{effective} ) & ( 6 ) \\ Total\_switching \_energy = rise\_power + 1 / 2 {C}_{load} \times {V}_{dd}^{2} & ( 7 ) \\ {I}_{max} = \frac{rise\_power + 1 / 2 {C}_{load} \times {V}_{dd}^{2}}{{V}_{dd} \times {T}_{effective}} & ( 8 )\end{matrix}$$

Equations (5) and (8) represent T_{effective} and Iₘₐₓ, respectively, and they are both a function of load capacitance and technology constants like supply voltage, V_{dd}. As will be appreciated by those of ordinary skill in the art, other parameters in equations (5) and (8), such as rise_transition, cell_rise and rise_power, are direct substitutions in digital library tables.

Thus, an injection macro-model according to various embodiments of the invention can employ a table created by substituting pre-characterized standard cells delays into model equations, i.e., equations (5), (6), (7) and (8), at each load capacitance value. In a noise assessment tool according to various embodiments of the invention, the load capacitance may be obtained through a conventional layout parasitic extraction (LPE) operation as part of the design flow. Also, as will be appreciated by those of ordinary skill in the art, the load capacitance for each gate/net exists in the standard delay format (SDF) file that is the standard output of static timing analysis solution tools.

An injection macro model according to various implementations of the invention may employ a pre-characterized standard cell library. These libraries are silicon proven in the marketplace by major foundries. Consequently, SPICE simulation results of standard cell extracted netlists can be considered a golden reference for comparison.

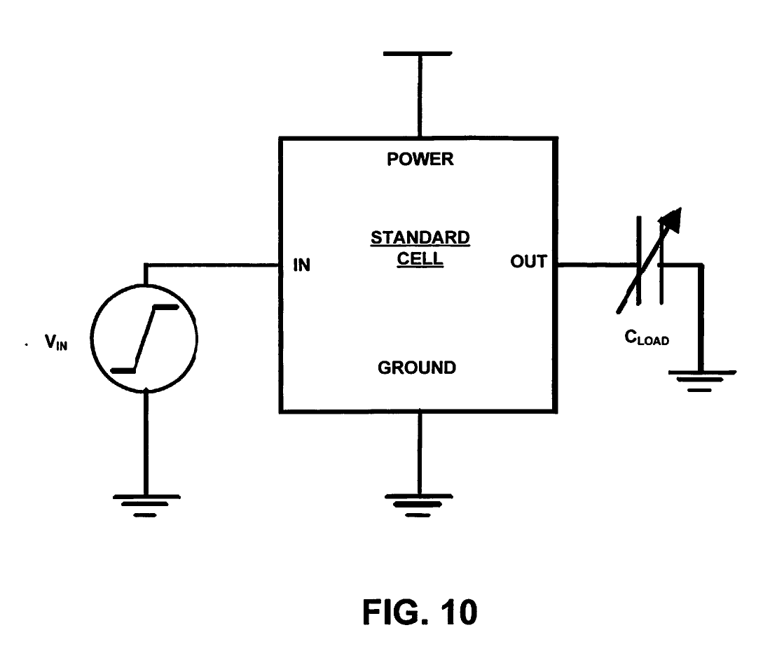

In order to obtain the golden reference, an LPE tool can be employed to accurately extract standard cell circuit with all parasitic participants from devices to interconnect. A simulation netlist can then be prepared for post-layout simulation by adding stimulus on the input side and then varying the load capacitance on the output side, as illustrated in FIG. 10. Both supply and ground currents can be monitored to represent golden reference data for each cell.

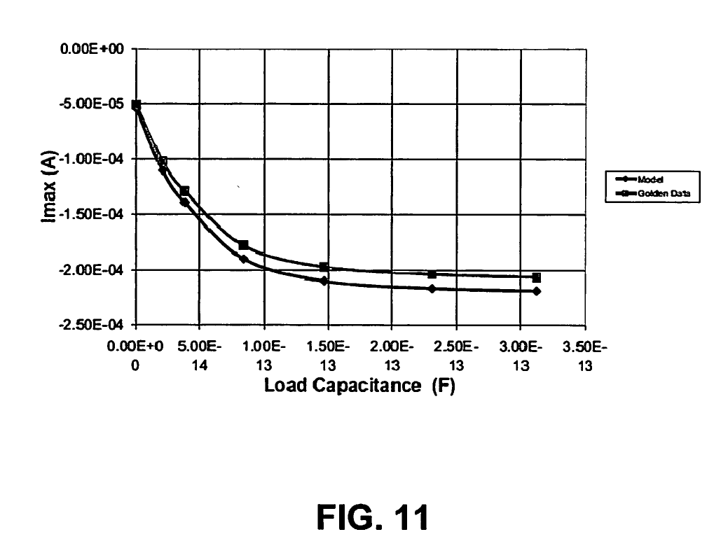

A validation graph is shown in FIG. 11 where the values of Iₘₐₓ that have been modeled according to various embodiments of the invention are compared against prospective values from a “golden reference” simulated netlist. It should be noted that model data values are very close to the golden reference values, and are following the same trend.

It is also should be noted that the macro-model according to various embodiments of the invention is predicting higher injection current than silicon. The reason for that is that the Iₘₐₓ model equation includes predicted T_{effective} values as variables. The value of T_{effective}, according to the model definition, is the gate's output toggling time from 10% to 90% of high state voltage.

With various implementations of the invention, T_{effective} can be chosen to cover a wider portion of switching time, leading Iₘₐₓ to reduce to a much closer value to the golden reference data. Another modeling approach can be employed according to various implementations of the invention by assuming a Gaussian model of the switching current waveform.

### Propogation Macro Model

Lightly doped substrates are commonly used in AMS and SOC designs. This is due to their high resistivity that ensures higher substrate noise isolation in comparison to heavily doped substrates. Additionally, propagation through lightly doped substrate is nearly frequency independent up to 50 GHz.

Recalling equations (2) through (4) discussed above, two substrate macro-model parameters are characterized according to various implementations of the invention. The first is the self resistance on the injector (digital) side, R_{sub}, and the second is the propagation loss factor from the injector to the receptor, α₁₂. With both parameters and the injection current value, Iₘₐₓ, the effective noise voltage at the receptor side, Vₙₒᵢₛₑ, can be calculated directly from equation (4) according to various embodiments of the invention.

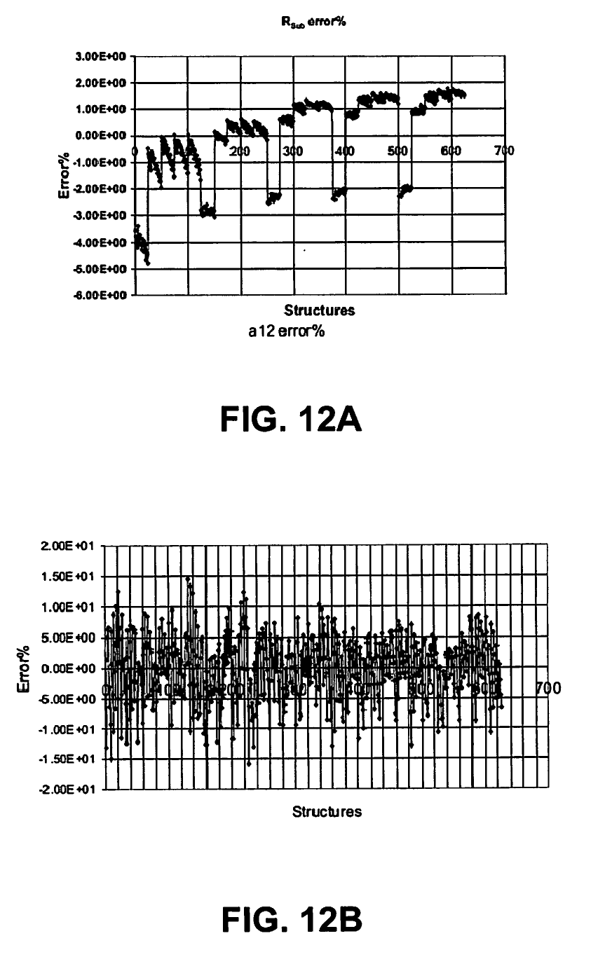

A modeling approach that may be employed according to various embodiments of the invention may employ a standard calibration/curve fitting process using field solver data performed over various test structures. As will be appreciated by those of ordinary skill in the art, these structures may cover a wide range of substrate contact geometries variation for both area and perimeter. The model functions may then be described as follows:

$${R}_{Sub} = \frac{1}{{K}_{1} + {K}_{2} \times A + {K}_{3} \times P} \qquad ( 9 )$$

where A is the substrate contact area, P is the perimeter, and K₁, K₂ and K₃ are fitting parameters to be calculated from the standard curve fitting process, and

$${α}_{12} = \frac{{e}^{{M}_{0} \times S}}{{M}_{1} + {M}_{2} \times {A}_{1} + {M}_{3} \times {P}_{1} + {M}_{4} \times {A}_{2} + {M}_{5} \times {P}_{2}} \qquad ( 10 )$$

where A₁, P₁, A₂ and P₂ are the area and perimeter for both the injector and the receptor respectively, S is the edge-to-edge spacing between two contacts, M₀, M₁, M₂, M₃, M₄ and M₅ are fitting parameters to be calculated from the standard curve fitting process. Error distribution versus field solver data is shown in FIGS. 12A and 12B. As seen in these figures, both R_{sub} and α₁₂ models show ˜0.01% average error, and a 1.5% and 5% Standard Deviation, respectively.

As will be apparent from the foregoing description, various embodiments of the invention provide injection modeling techniques that predict supply switching currents in digital gates, and, hence, their substrate injected noise currents. Further, various embodiments of the invention provide propagation models that deliver means of transforming injected currents into the resulting noise effect on the receptor side. Thus, with various embodiments of the invention, no transistor level simulation is needed for digital circuits.

Moreover, as will be apparent from the foregoing description, various implementations of the invention can provide a substrate noise coupling tool with the ability to perform analog SPICE simulations encompassing the substrate noise effect, sighting high noise areas before sensitive analog block placement and verifying chip level noise immunity through noise ceiling specification.

With the aid of injection and propagation models according to various embodiments of the invention, noise effect can be represented from the receptor side, e.g., an analog transistor, through a voltage noise source connected to its bulk node, as shown in FIG. 7 above. The value of this voltage noise is basically the Thevinen's equivalent of the whole network. One part is the noise voltage at injector side given by equation (2) and the other part is the substrate resistance modeled by a propagation macro-model according to various embodiments of the invention. The supply rail currents can then be acquired from a “state file” produced by a digital simulator, which contains the state, rising/falling, of all standard cells used in the design. The value of this approach is avoiding simulator's calculations of all gates supply current which needs full transistor level simulation.

The knowledge of how much noise is injected from each gate, how much noise voltage is produced on gate side and how it is attenuated through substrate propagation till it reaches analog transistors enables the tool to calculate noise levels designated to each transistor. By substitution in the equations of both macro-models, injection and propagation, noise level at each part of the chip can be calculated and summed out for all gates. Designers can specify certain noise ceiling above which a violation is flagged out for corrective action.

With some implementations of the invention, back annotating noise levels, at each point of the chip as mentioned above, to design layout will produce noise contours that are colored according to noise strength level. This noise map can be very useful for system integration where choosing the analog block placement is a tough decision.

As will be appreciated by those of ordinary skill in the art, a standard physical verification EDA tool can be used to perform this type of analysis by associating model equations to each substrate contact of the design. The tool processes the layout and substitute model variables into model equations. Finally, a substrate noise map can be produced.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

1. One or more computer readable media storing computer-executable instructions for causing a computer to perform any of the new and nonobvious methods and method acts described herein, both alone and in combinations and subcombinations with one another.

2. A method of assessing substrate noise for an integrated circuit design, comprising any of the new and nonobvious methods and method acts described herein, both alone and in combinations and subcombinations with one another.

3. One or more computer readable media storing instructions for assessing substrate noise for an integrated circuit design in accordance with any of the new and nonobvious methods and method acts described herein both alone and in combinations and subcombinations with one another.

4. (canceled)

5. (canceled)
